(19) United States
(12) Patent Application Publication
(10) Pub. No.: US 2024/0323850 A1
(43) Pub. Date: Sep. 26, 2024

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/733,019

(22) Filed: Jun. 4, 2024

Related U.S. Application Data
(63) Continuation of application No. PCT/CN2021/136582, filed on Dec. 8, 2021.

(51) Int. Cl. H04W 52/02; H04W 72/231; H04W 76/28

(52) U.S. Cl. CPC H04W 52/0235; H04W 72/231; H04W 76/28

(57) ABSTRACT

A wireless communication method, a terminal device, and a network device are provided, which are conducive to both power saving of the terminal device and reducing service delay of the terminal device. The method includes the following. A terminal device receives a low-power wake-up signal (LP-WUS) from a network device. The terminal device performs physical downlink control channel (PDCCH) monitoring after a first time offset starting from when the LP-WUS is received.

### CROSS-REFERENCE TO RELATED APPLICATION(S)

This application is a continuation of International Application No. PCT/CN2021/136582, filed Dec. 8, 2021, the entire disclosure of which is incorporated herein by reference.

### TECHNICAL FIELD

Embodiments of the disclosure relate to the field of communication, and more particularly, to a wireless communication method, a terminal device, and a network device.

### BACKGROUND

In a discontinuous reception (DRX) mechanism, in order to reduce power consumption of a terminal, a wake-up signal (WUS) is introduced. A terminal device starts blind detection of the WUS at an offset time before a start time of a DRX on-duration timer (drx-ondurationTimer) corresponding to each long DRX cycle. If the WUS is detected and the WUS indicates that the terminal device is to wake up, the terminal device starts drx-onduration Timer during the long DRX cycle. If the WUS is detected but the WUS indicates that the terminal device is not to wake up, the terminal device does not start drx-onduration Timer.

In order to further reduce power consumption of the terminal, an (ultra-)low power WUS (LP-WUS) is introduced. Before the LP-WUS is received by the terminal device, a main receiver of the terminal device is off or in a deep sleep state, and the main receiver will be turned on to monitor a downlink (DL) signal only after the LP-WUS is received by the terminal device, so as to realize power saving. However, after introduction of the LP-WUS, how the terminal device performs DRX in a connected state is a problem to be solved.

### SUMMARY

In a first aspect, a wireless communication method is provided. The method includes the following. A terminal device receives an LP-WUS from a network device. The terminal device performs PDCCH monitoring after a first time offset starting from when the LP-WUS is received.

In a second aspect, a wireless communication method is provided. The method includes the following. A network device sends an LP-WUS to a terminal device. The network device sends a PDCCH after a first time offset starting from when the LP-WUS is sent.

In a third aspect, a terminal device is provided. The terminal device includes a transceiver, a processor and a memory. The memory is configured to store computer programs. The processor is configured to invoke and execute the computer programs stored in the memory, so as to implement the method in the first aspect or various implementations of the first aspect.

### BRIEF DESCRIPTION OF THE DRAWINGS

FIG. 1 is a schematic diagram illustrating an application scenario provided in embodiments of the disclosure.

FIG. 2 is a schematic block diagram illustrating discontinuous reception (DRX) according to embodiments of the disclosure.

FIG. 3 is a schematic diagram illustrating working principles of a low-power wake-up signal (LP-WUS) mechanism.

FIG. 4 is a schematic diagram of a wireless communication method provided in embodiments of the disclosure.

FIG. 5 is a schematic diagram of a wireless communication method according to an embodiment of the disclosure.

FIG. 6 is a schematic diagram of a wireless communication method according to another embodiment of the disclosure.

FIG. 7 is a schematic diagram of a wireless communication method according to another embodiment of the disclosure.

FIG. 8 is a schematic block diagram of a terminal device according to embodiments of the disclosure.

FIG. 9 is a schematic block diagram of a network device according to embodiments of the disclosure.

FIG. 10 is a schematic block diagram of a communication device provided in an embodiment of the disclosure.

FIG. 11 is a schematic block diagram of a chip provided in embodiments of the disclosure.

FIG. 12 is a schematic block diagram of a communication system provided in embodiments of the disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long-term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5^{th}-generation (5G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

Optionally, the communication system in embodiments of the disclosure may be applied to a carrier aggregation (CA) scenario, or may be applied to a dual connectivity (DC) scenario, or may be applied to a standalone (SA) network deployment scenario.

Optionally, the communication system in embodiments of the disclosure is applicable to an unlicensed spectrum, and an unlicensed spectrum may be regarded as a shared spectrum. Alternatively, the communication system in embodiments of the disclosure is applicable to a licensed spectrum, and a licensed spectrum may be regarded as a non-shared spectrum.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), various devices with wireless communication functions such as a handheld device or a computing device, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device (gNB) in an NR network, a network device in a future evolved PLMN, or a network device in an NTN, etc.

By way of explanation rather than limitation, in embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

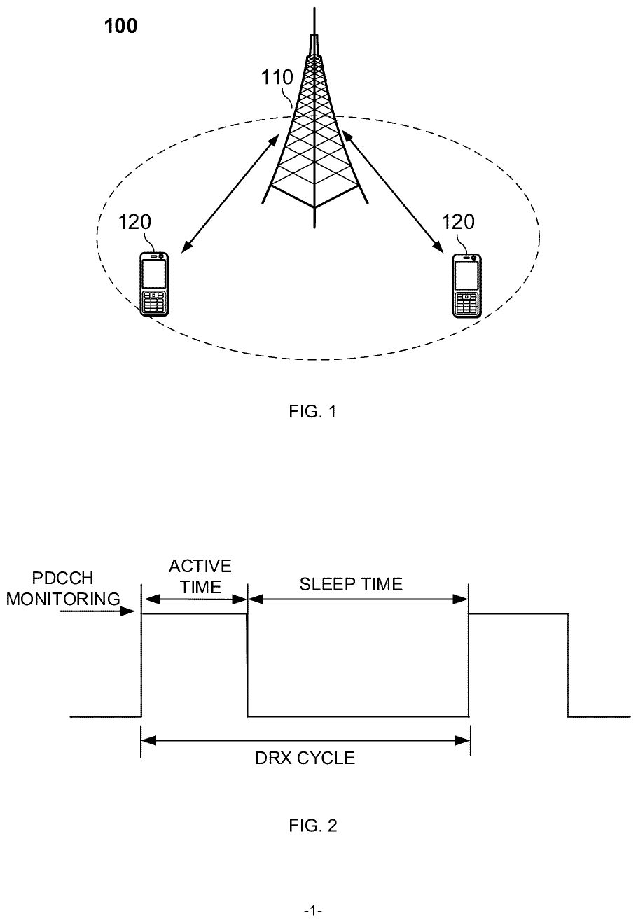

Exemplarily, FIG. 1 illustrates a communication system 100 to which embodiments of the disclosure are applied. The communication system 100 may include a network device 110. The network device 110 may be a device for communicating with a terminal device 120 (also referred to as “communication terminal” or “terminal”). The network device 110 can provide a communication coverage for a specific geographical area and communicate with terminal devices in the coverage area.

FIG. 1 exemplarily illustrates one network device and two terminal devices. Optionally, the communication system 100 may also include multiple network devices, and there can be other quantities of terminal devices in a coverage area of each of the network devices. Embodiments of the disclosure are not limited in this regard.

Optionally, the communication system 100 may further include other network entities such as a network controller, a mobility management entity, or the like, and embodiments of the disclosure are not limited in this regard.

It should be understood that, in embodiments of the disclosure, a device with communication functions in a network/system can be referred to as a “communication device”. Taking the communication system 100 illustrated in FIG. 1 as an example, the communication device may include the network device 110 and the terminal device(s) 120 that have communication functions. The network device 110 and the terminal device(s) 120 can be the devices described above and will not be elaborated again herein. The communication device may further include other devices such as a network controller, a mobility management entity, or other network entities in the communication system 100, and embodiments of the disclosure are not limited in this regard.

It should be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that that there is an association between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In embodiments of the disclosure, the “pre-defined” can be implemented by pre-storing a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

Indication information in embodiments of the disclosure is configured via at least one of the following signaling: a system message, physical-layer signaling (such as downlink control information (DCI)), radio resource control (RRC) signaling, or a media access control-control element (MAC CE).

With people's pursuit of speed, delay, high-speed mobility, and energy efficiency, as well as diversity and complexity of services in future life, the 3rd generation partnership project (3GPP) international standard organization began to research and develop 5G. 5G is mainly applied to enhanced mobile broadband (eMBB), ultra-reliable low-latency communication (URLLC), and massive machine-type communication (mMTC).

It should be understood that, in embodiments of the disclosure, NR may also be deployed separately. In a 5G network environment, a new RRC state, namely an RRC_INACTIVE state, is defined in order to reduce air-interface signaling, realize quick recovery of radio connection, and realize quick recovery of data service. This state is different from an RRC_IDLE state and an RRC_CONNECTED state.

In the RRC_IDLE state, mobility is based on cell selection and re-selection of a terminal device. Paging is initiated by a core network (CN), and a paging area is configured by the CN. A base-station side does not have terminal-device access stratum (AS) context or RRC connection.

In the RRC_CONNECTED state, there is an RRC connection. Both a base station and the terminal device have terminal-device AS context. A network device knows that a location of the terminal device is cell level-based. Mobility is controlled by the network device. Unicast data can be transmitted between the terminal device and the base station.

RRC_INACTIVE: mobility is based on cell selection and re-selection of the terminal device. There is a CN-NR connection. Some base station has terminal-device AS context. Paging is triggered by a radio access network (RAN), a RAN-based paging area is managed by the RAN, and the network device knows that the location of the terminal device is RAN-based paging area level.

It should be noted that, in embodiments of the disclosure, the inactive state may also be referred to as a deactivated state, and the disclosure is not limited in this regard.

In some scenarios, in order to realize power saving of a terminal, a concept of discontinuous reception (DRX) is proposed. Specifically, the network device may configure the terminal device to wake up (DRX ON) at a time predicted by the network so as to perform physical downlink control channel (PDCCH) monitoring. In addition, the network may also configure the terminal device to sleep (DRX OFF) at a time predicted by the network, that is, the terminal device does not have to perform PDCCH monitoring. Thus, if the network device has data that is to be transmitted to the terminal device, the network device may schedule the terminal device when the terminal device is in a DRX ON time, while during a DRX OFF time, since radio frequency is turned off, power consumption of the terminal can be reduced.

As illustrated in FIG. 2, a DRX cycle configured by the network device for the terminal device includes an active time (on duration) and a sleep time (opportunity for DRX). In an RRC CONNECTED mode, if the terminal device is configured with a DRX functionality, the terminal device monitors and receives a PDCCH during the on duration; and the terminal device does not perform PDCCH monitoring during the sleep time in order to reduce power consumption.

It should be understood that, in embodiments of the disclosure, the terminal device in the sleep time does not receive a PDCCH, but may receive data from other physical channels, which is not limited in embodiments of the disclosure. For example, the terminal device may receive a physical downlink shared channel (PDSCH), an acknowledgement/negative acknowledgement (ACK/NACK), etc. For another example, in semi-persistent scheduling (SPS), the terminal device may receive PDSCH data that is configured periodically.

In some embodiments, a MAC entity may be configured with a DRX functionality via RRC signaling, where the DRX functionality is used for controlling PDCCH monitoring activity of the terminal device. That is, each MAC entity may correspond to one DRX configuration. Optionally, the DRX configuration may include at least one of the following:
DRX on-duration timer (drx-onDurationTimer): a duration of wake-up of the terminal device at the beginning of a DRX cycle.
DRX slot offset (drx-SlotOffset): a delay before the terminal device starts drx-onDurationTimer.
DRX inactivity timer (drx-InactivityTimer): a duration for which the terminal device continues PDCCH monitoring after a PDCCH indicating a new uplink (UL) or downlink (DL) transmission is received by the terminal device.
DRX DL retransmission timer (drx-RetransmissionTimerDL): a maximum duration until a PDCCH indicating DL retransmission scheduling is monitored by the terminal device. Each DL hybrid automatic repeat request (HARQ) process, except for a broadcast HARQ process, corresponds to one drx-Retransmission TimerDL.
DRX UL retransmission timer (drx-RetransmissionTimerUL): a maximum duration until a PDCCH indicating UL retransmission scheduling is monitored by the terminal device. Each UL HARQ process corresponds to one drx-Retransmission TimerUL.
Long DRX cycle start offset (longDRX-CycleStartOffset): used for configuring a long DRX cycle, as well as a subframe offset from which a long DRX cycle and a short DRX cycle start.
Short DRX cycle (drx-ShortCycle): a short DRX cycle, which is optional.
Short cycle timer (drx-ShortCycle Timer): a duration for which the terminal device is in a short DRX cycle (and no PDCCH is received), which is optional.
DL HARQ round trip time (RTT) timer (drx-HARQ-RTT-TimerDL): a minimum waiting time required before a PDCCH indicating DL scheduling is expected to be received by the terminal device. Each DL HARQ process, except for a broadcast HARQ process, corresponds to one HARQ RTT timer.
UL HARQ RTT timer (drx-HARQ-RTT-TimerUL): a minimum waiting time required before a PDCCH indicating UL scheduling is expected to be received by the terminal device. Each UL HARQ process corresponds to one drx-HARQ-RTT-TimerUL.

If the terminal device is configured with DRX, the terminal device needs to perform PDCCH monitoring in a DRX active time. The DRX active time includes the following cases: any one of drx-onDurationTimer, drx-Inactivity Timer, drx-RetransmissionTimerDL, drx-RetransmissionTimerUL, or a random access contention resolution timer (ra-ContentionResolutionTimer) is running; a scheduling request (SR) is sent on a PUCCH by the terminal device and is pending; in a contention-based random access procedure, a PDCCH indicating a new transmission and scrambled by a cell radio network temporary identifier (cell RNTI, C-RNTI) has not been received by the terminal device after successful reception of a random access response.

In some embodiments, the terminal device uses a long DRX cycle by default, while a short DRX cycle is optional. The terminal device configured with the short DRX cycle can switch between the short DRX cycle and the long DRX cycle in some manner.

In some embodiments, the terminal device uses the long DRX cycle if drx-Inactivity Timer expires and/or a DRX command MAC CE is received by the terminal device.

In some embodiments, the terminal device uses the short DRX cycle if drx-ShortCycleTimer expires and/or a long DRX command MAC CE is received by the terminal device.

In some embodiments, the terminal device may determine a time at which the drx-onDuration Timer is started, based on whether the terminal device is currently in the long DRX cycle or is currently in the short DRX cycle.

For example, if the short DRX cycle is used, and a current subframe satisfies [(SFN×10)+subframe number] modulo (drx-ShortCycle)=(drx-StartOffset) modulo (drx-ShortCycle).

For another example, if the long DRX cycle is used, and the current subframe satisfies [(SFN×10)+subframe number] modulo (drx-LongCycle)=drx-StartOffset.

“modulo” represents a modulo operation.

In some embodiments, the terminal device may start drx-onDurationTimer after drx-SlotOffset slots starting from the beginning of the current subframe.

In some embodiments, a condition for starting or restarting drx-Inactivity Timer includes, but is not limited to: if a PDCCH indicating a new DL or UL transmission is received by the terminal device, the terminal device starts or restarts drx-Inactivity Timer.

In some embodiments, a condition for starting or stopping drx-RetransmissionTimerDL includes, but is not limited to: if a PDCCH indicating DL transmission is received by the terminal device or a MAC PDU is received by the terminal device on a configured DL grant, the terminal device stops drx-Retransmission TimerDL for a corresponding HARQ process; and if drx-HARQ-RTT-TimerDL corresponding to a HARQ process for the terminal device expires and DL data transmitted by using the HARQ process was not successfully decoded, the terminal device starts drx-RetransmissionTimerDL corresponding to the HARQ process.

In some embodiments, a condition for the terminal device to start or stop drx-RetransmissionTimerUL includes, but is not limited to: if a PDCCH indicating UL transmission is received by the terminal device or a MAC PDU is transmitted by the terminal device on a configured UL grant, the terminal device stops drx-RetransmissionTimerUL for a corresponding HARQ process, and the terminal device starts drx-HARQ-RTT-TimerUL corresponding to the HARQ process after the end of a 1^{st} PUSCH repetition; and if drx-HARQ-RTT-TimerUL corresponding to a HARQ process for the terminal expires, the terminal starts drx-Retransmission TimerUL corresponding to the HARQ process.

In an NR system, in order to reduce power consumption of the terminal, a power saving signal is introduced. The terminal device starts blind detection of a PDCCH-based power saving signal (i.e. PDCCH-wake-up signal (PDCCH-WUS)) at an offset time before a start time of drx-ondurationTimer corresponding to each long DRX cycle. If the PDCCH-WUS is detected and the WUS indicates that the terminal device is to wake up, the terminal device starts drx-onduration Timer during the long DRX cycle. If the PDCCH-WUS is detected and the WUS indicates that the terminal device is not to wake up, the terminal device does not start drx-ondurationTimer.

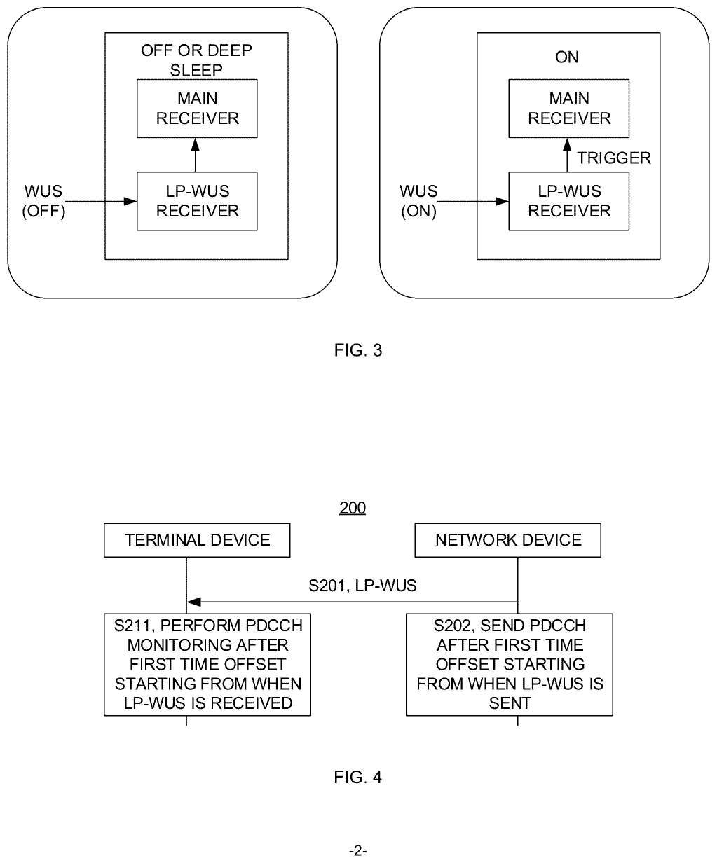

The foregoing power-saving technology is designed for the case where a main receiver of the terminal device stays in an on state. In order to further reduce power consumption of the terminal, an (ultra-)low power WUS (LP-WUS) is introduced. FIG. 3 is a schematic diagram illustrating working principles of the LP-WUS. The terminal device includes the main receiver (or referred to as a main radio) and an LP-WUS receiver, where power consumption of the LP-WUS receiver is lower than power consumption of the main receiver. Before the LP-WUS is received by the terminal device, the main receiver is off or in a deep sleep state, and the main receiver will be turned on to monitor a DL signal only after the LP-WUS is received by the terminal device, so as to realize power saving. However, after the introduction of the LP-WUS, how the terminal device performs DRX in a connected state is a problem to be solved.

To this end, the disclosure provides a scheme for PDCCH monitoring. A terminal device performs PDCCH monitoring after a first time interval starting from when an LP-WUS is received, where the first time interval may be designed according to a warm-up time of a main receiver. In this way, the terminal device does not have to perform PDCCH monitoring before the main receiver is woken up, which is beneficial to reducing power consumption of the terminal. In addition, after the main receiver is woken up, the terminal device can enter an active time as soon as possible to perform PDCCH monitoring, which is beneficial to reducing service delay of the terminal device.

In order to facilitate understanding of technical solutions of embodiments of the disclosure, technical solutions of the disclosure will be described in detail below with reference to specific embodiments. The following related art as an optional solution can be arbitrarily combined with the technical solutions of embodiments of the disclosure, which shall all belong to the protection scope of embodiments of the disclosure. Embodiments of the disclosure include at least some of the following content.

The disclosure provides a wireless communication method, a terminal device, and a network device. The terminal device can perform physical downlink control channel (PDCCH) monitoring after a first time offset starting from when a low-power wake-up signal (LP-WUS) is received, which is beneficial to reducing service delay of the terminal device while realizing power saving of the terminal device.

FIG. 4 is a schematic interaction diagram of a wireless communication method 200 according to embodiments of the disclosure. As illustrated in FIG. 4, the method 200 includes the following.

S201, a network device sends an LP-WUS to a terminal device.

Accordingly, the terminal device receives the LP-WUS from the network device.

S211, the terminal device performs PDCCH monitoring after a first time offset starting from when the LP-WUS is received.

Correspondingly, S202, the network device sends a PDCCH after the first time offset starting from when the LP-WUS is sent.

In some embodiments, the terminal device may include a first receiver and a second receiver, where power consumption of the first receiver is higher than power consumption of the second receiver. That is, compared with using the first receiver to receive a DL signal, if the second receiver is used to receive a DL signal, it is more beneficial to power saving of the terminal.

In embodiments of the disclosure, the first receiver is referred to as a main receiver, and the second receiver is referred to as an LP-WUS receiver.

In some embodiments, before the LP-WUS is received by the terminal device, the terminal device in an RRC_CONNECTED state is in a low power receiver state, that is, the main receiver of the terminal device is in an off state or in a deep sleep state while the LP-WUS receiver is in an operating state, and the terminal device monitors the LP-WUS via the LP-WUS receiver.

In some embodiments, after the LP-WUS is received by the terminal device, the terminal device wakes up the main receiver. After the main receiver is woken up, the terminal device may receive a DL signal, for example, perform PDCCH monitoring, via the main receiver.

Optionally, waking up the main receiver may be any operation that can enable the main receiver to enter the operating state, for example, including but not limited to the following operations of the main receiver: a turning-on operation, crystal oscillator stabilization, a coarse synchronization operation, and a fine synchronization operation.

In some embodiments of the disclosure, the first time offset is determined by the terminal device.

For example, the terminal device may determine the first time offset according to a warm-up time of the main receiver.

Optionally, the terminal device may determine the warm-up time of the main receiver as the first time offset.

Optionally, the warm-up time of the main receiver may be a time elapsed from when the LP-WUS is received by the terminal device to when the main receiver of the terminal device is woken up to receive a DL message (for example, to receive a PDCCH and/or a PDSCH).

As an example, the warm-up time of the main receiver may include a time required to perform the following operations of the main receiver: a turning-on operation, crystal oscillator stabilization, a coarse synchronization operation, and a fine synchronization operation.

In some embodiments, the method 200 further includes the following. The terminal device sends first indication information to the network device, where the first indication information indicates the first time offset or the warm-up time of the main receiver. That is, the terminal device may directly or indirectly indicate the first time offset to the network device, and the network device may determine the first time offset according to the first indication information.

In some other embodiments of the disclosure, the first time offset is configured by the network device.

For example, the network device may send second indication information to the terminal device, where the second indication information indicates the first time offset.

Optionally, the second indication information is sent via UE-specific signaling.

As an example, the UE-specific signaling may be RRC signaling or a MAC CE.

In some embodiments, the network device may determine the first time offset based on a capability of the terminal device.

For example, the terminal device may report the warm-up time of the main receiver to the network device, and the network device may determine the first time offset according to the warm-up time of the main receiver reported by the terminal device. As an example, the network device may determine the warm-up time of the main receiver as the first time offset, and then indicate the first time offset to the terminal device.

It should be understood that, in embodiments of the disclosure, within the first time offset starting from when the LP-WUS is received by the terminal device, it may be considered that the main receiver of the terminal device is not yet ready to receive a DL signal, and therefore, the terminal device does not have to enter a DRX active time during this period, which is beneficial to power saving of the terminal. After the first time offset starting from when the LP-WUS is received, it may be considered that the main receiver of the terminal device is ready to receive a DL signal, and in this case, the terminal device enters the DRX active time, which is beneficial to reducing service delay of the terminal device.

With the technical solutions, the terminal device can perform PDCCH monitoring after the first time offset starting from when the LP-WUS is received, which is beneficial to reducing service delay of the terminal device while realizing power saving of the terminal device.

The implementation of LP-WUS-based DRX will be described below with reference to specific embodiments.

### Embodiment 1

In Embodiment 1, after the first time offset starting from when the LP-WUS is received, the terminal device starts drx-Inactivity Timer to enter the DRX active time, so as to perform PDCCH monitoring.

It should be understood that, in Embodiment 1, the network device and the terminal device have consistent understanding of the DRX active time, that is, the network device knows that after the first time offset starting from when the LP-WUS is received, the terminal device starts drx-InactivityTimer to enter the DRX active time. In this case, the network device may send a PDCCH during the DRX active time.

Optionally, if a PDCCH indicating new-transmission scheduling is received by the terminal device while drx-Inactivity Timer is runnning, the terminal device restarts drx-Inactivity Timer.

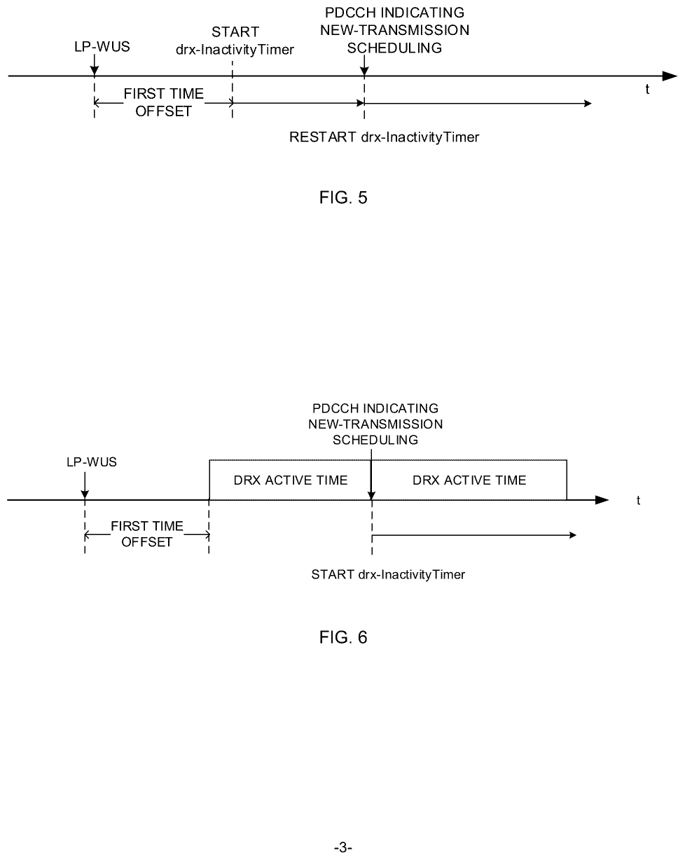

The procedure of Embodiment 1 will be described in detail with reference to FIG. 5.

Specifically, the main receiver of the terminal device is in the off state or in the deep sleep state, and the terminal device monitors the LP-WUS via the LP-WUS receiver.

Then, after the LP-WUS is received by the LP-WUS receiver of the terminal device, the terminal device wakes up the main receiver, for example, performs a turning-on operation, crystal oscillator stabilization, a coarse synchronization operation, and a fine synchronization operation of the main receiver.

After the first time offset starting from when the LP-WUS is received, the terminal device starts drx-InactivityTimer to enter the DRX active time, so as to perform PDCCH monitoring, for example, the terminal device performs PDCCH monitoring via the main receiver.

Optionally, if a PDCCH indicating new-transmission scheduling is received by the terminal device while drx-Inactivity Timer is running, the terminal device restarts drx-Inactivity Timer.

### Embodiment 2

In Embodiment 2, after the first time offset starting from when the LP-WUS is received, the terminal device enters the DRX active time to perform PDCCH monitoring.

Optionally, the terminal device stays in the DRX active time before a PDCCH indicating scheduling is received.

Different from Embodiment 1, in Embodiment 2, a duration for which the terminal device is in the DRX active time is not restricted, while in Embodiment 1, the duration for which the terminal device is in the DRX active time is restricted by a duration of drx-Inactivity Timer.

It should be understood that, in Embodiment 2, the network device and the terminal device have consistent understanding of the DRX active time, that is, the network device knows that the terminal device enters the DRX active time after the first time offset starting from when the LP-WUS is received. In this case, the network device may send a PDCCH during the DRX active time.

Optionally, if a PDCCH indicating scheduling is received by the terminal device during the DRX active time, the terminal device starts drx-InactivityTimer.

The procedure of Embodiment 2 will be described in detail with reference to FIG. 6.

Specifically, the main receiver of the terminal device is in the off state or in the deep sleep state, and the terminal device monitors the LP-WUS via the LP-WUS receiver.

Then, after the LP-WUS is received by the LP-WUS receiver of the terminal device, the terminal device wakes up the main receiver, for example, performs a turning-on operation, crystal oscillator stabilization, a coarse synchronization operation, and a fine synchronization operation of the main receiver.

After the first time offset starting from when the LP-WUS is received, the terminal device enters the DRX active time, so as to perform PDCCH monitoring.

Optionally, if a PDCCH indicating scheduling is received by the terminal device during the DRX active time, the terminal device starts drx-InactivityTimer.

### Embodiment 3

In Embodiment 3, the terminal device is configured with a short DRX cycle.

The terminal device uses the short DRX cycle, and starts drx-ShortCycle Timer after the first time offset starting from when the LP-WUS is received. Further, the terminal device performs PDCCH monitoring while drx-ondurationTimer for the short DRX cycle is running, that is, the terminal device enters the DRX active time while drx-onduration Timer for the short DRX cycle is running.

It should be understood that, in Embodiment 3, the network device and the terminal device have consistent understanding of the DRX active time, that is, the network device knows that the terminal device uses the short DRX cycle, and starts drx-ShortCycleTimer after the first time offset starting from when the LP-WUS is received. In this case, the network device may send a PDCCH while drx-onduration Timer for the short DRX cycle is running.

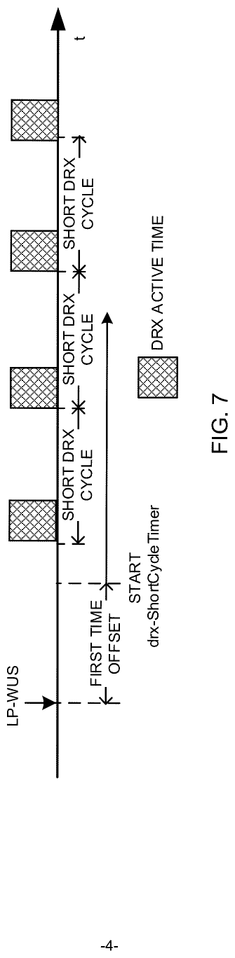

The procedure of Embodiment 3 will be described in detail with reference to FIG. 7.

Specifically, the main receiver of the terminal device is in the off state or in the deep sleep state, and the terminal device monitors the LP-WUS via the LP-WUS receiver.

Then, after the LP-WUS is received by the LP-WUS receiver of the terminal device, the terminal device wakes up the main receiver, for example, performs a turning-on operation, crystal oscillator stabilization, a coarse synchronization operation, and a fine synchronization operation of the main receiver.

The terminal device uses the short DRX cycle, and starts drx-ShortCycle Timer after the first time offset starting from when the LP-WUS is received. During running of drx-onduration Timer for the short DRX cycle, the terminal device enters the DRX active time so as to perform PDCCH monitoring.

Therefore, in embodiments of the disclosure, the terminal device does not perform PDCCH monitoring within the first time offset starting from when the LP-WUS is received, and enters the DRX active time as soon as possible after the first time offset to perform PDCCH monitoring, for example, enters the DRX active time directly after the first time offset, or starts drx-Inactivity Timer to enter the DRX active time, or uses the short DRX cycle and start drx-ShortCycle Timer to enter the DRX active time, which is conducive to reducing service delay of the terminal device while realizing power saving of the terminal device.

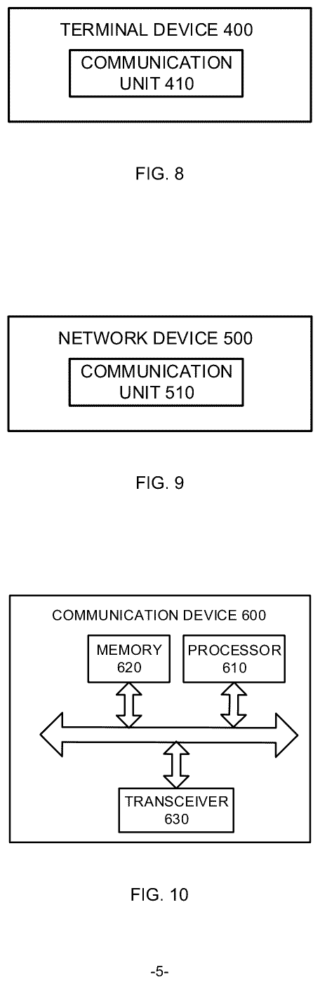

The method embodiments of the disclosure are described in detail above with reference to FIG. 4 to FIG. 7, and apparatus embodiments of the disclosure will be described in detail below with reference to FIG. 8 to FIG. 12. It should be understood that, the apparatus embodiments and the method embodiments correspond to each other, and for similar elaboration, reference can be made to the method embodiments.

FIG. 8 is a schematic block diagram of a terminal device 400 according to embodiments of the disclosure. As illustrated in FIG. 8, the terminal device 400 includes a communication unit 410. The communication unit 410 is configured to receive an LP-WUS from a network device, and perform PDCCH monitoring after a first time offset starting from when the LP-WUS is received.

In some embodiments of the disclosure, the terminal device 400 further includes a processing unit. The processing unit is configured to start a DRX inactivity timer to enter a DRX active time, after the first time offset starting from when the LP-WUS is received.

In some embodiments of the disclosure, the terminal device further includes a processing unit. The processing unit is configured to enter a DRX active time after the first time offset starting from when the LP-WUS is received.

In some embodiments of the disclosure, the terminal device stays in the DRX active time before a PDCCH indicating scheduling is received.

In some embodiments of the disclosure, the terminal device 400 further includes a processing unit. The processing unit is configured to use a short DRX cycle, and start a DRX short cycle timer after the first time offset starting from when the LP-WUS is received.

In some embodiments of the disclosure, the communication unit 410 is further configured to perform PDCCH monitoring while a DRX on-duration timer for the short DRX cycle is running.

In some embodiments of the disclosure, the communication unit 410 includes a first receiving unit and a second receiving unit, where power consumption of the first receiving unit is higher than power consumption of the second receiving unit, and the LP-WUS is received by the second receiving unit.

In some embodiments of the disclosure, the first time offset is determined by the terminal device according to a warm-up time of the first receiver, and the warm-up time of the first receiver includes a time elapsed from when the LP-WUS is received by the terminal device to when the first receiving unit of the terminal device is woken up to receive a DL message.

In some embodiments of the disclosure, the communication unit 410 is further configured to send first indication information to the network device, where the first indication information indicates the first time offset.

In some embodiments of the disclosure, the first time offset is configured by the network device.

In some embodiments of the disclosure, the first time offset is configured by the network device via RRC signaling or a MAC CE.

In some embodiments of the disclosure, the first time offset is determined by the network device according to a warm-up time reported by the terminal device, and the warm-up time includes a time elapsed from when the LP-WUS is received by the terminal device to when the first receiving unit of the terminal device is woken up to receive a DL message.

In some embodiments of the disclosure, the terminal device 400 further includes a processing unit. The processing unit is configured to wake up the first receiving unit of the terminal device when the LP-WUS is received.

Optionally, in some embodiments, the communication unit may be a communication interface or a transceiver, or an input/output interface of a communication chip or a system-on-chip (SOC). The processing unit may be one or more processors.

It should be understood that, the terminal device 400 according to embodiments of the disclosure may correspond to the terminal device in the method embodiments of the disclosure, and the foregoing and other operations and/or functions of various units in the terminal device 400 are respectively intended for implementing corresponding operations of the terminal device in the method 200 illustrated in FIG. 4 to FIG. 7, which will not be described again herein for the sake of brevity.

FIG. 9 is a schematic block diagram of a network device according to embodiments of the disclosure. The network device 500 in FIG. 9 includes a communication unit 510. The communication unit 510 is configured to send an LP-WUS to a terminal device, and send a PDCCH after a first time offset starting from when the LP-WUS is sent.

In some embodiments of the disclosure, the communication unit 510 is further configured to send the PDCCH while a DRX inactivity timer for the terminal device is running, where the DRX inactivity timer is started by the terminal device after the first time offset starting from when the LP-WUS is received.

In some embodiments of the disclosure, the communication unit 510 is further configured to send the PDCCH after the terminal device enters a DRX active time, where the terminal device enters the DRX active time after the first time offset starting from when the LP-WUS is received.

In some embodiments of the disclosure, the PDCCH is sent while a DRX on-duration timer for a short DRX cycle is running.

In some embodiments of the disclosure, the communication unit 510 is further configured to receive first indication information sent by the terminal device, where the first indication information indicates the first time offset.

In some embodiments of the disclosure, the communication unit 510 is further configured to send second indication information to the terminal device, where the second indication information indicates the first time offset.

In some embodiments of the disclosure, the second indication information is sent via RRC signaling or a MAC CE.

In some embodiments of the disclosure, the first time offset is determined by the network device according to a warm-up time reported by the terminal device, and the warm-up time includes a time elapsed from when the LP-WUS is received by the terminal device to when a first receiver of the terminal device is woken up to receive a DL message.

In some embodiments of the disclosure, the terminal device includes the first receiver and a second receiver, where power consumption of the first receiver is higher than power consumption of the second receiver, and the LP-WUS is received by the terminal device via the second receiver.

Optionally, in some embodiments, the communication unit may be a communication interface or a transceiver, or an input/output interface of a communication chip or an SOC. The processing unit may be one or more processors.

It should be understood that, the network device 500 according to embodiments of the disclosure may correspond to the network device in the method embodiments of the disclosure, and the foregoing and other operations and/or functions of various units in the network device 500 are respectively intended for implementing corresponding operations of the network device in the method 200 illustrated in FIG. 4 to FIG. 7, which will not be described again herein for the sake of brevity.

FIG. 10 is a schematic structural diagram of a communication device 600 provided in embodiments of the disclosure. The communication device 600 illustrated in FIG. 10 includes a processor 610. The processor 610 can invoke and execute computer programs stored in a memory, to implement the method in embodiments of the disclosure.

Optionally, as illustrated in FIG. 10, the communication device 600 may further include a memory 620, where the processor 610 can invoke and execute computer programs stored in the memory 620, to implement the method in embodiments of the disclosure.

The memory 620 may be a separate device independent of the processor 610, or may be integrated into the processor 610.

Optionally, as illustrated in FIG. 10, the communication device 600 may further include a transceiver 630. The processor 610 can control the transceiver 630 to communicate with other devices, and specifically, to send information or data to other devices or receive information or data sent by other devices.

The transceiver 630 may include a transmitter and a receiver. The transceiver 630 can further include an antenna, where one or more antennas may be provided.

Optionally, the communication device 600 may specifically be a network device in embodiments of the disclosure, and the communication device 600 may implement corresponding operations implemented by the network device in various methods in embodiments of the disclosure, which will not be described again herein for the sake of brevity.

Optionally, the communication device 600 may specifically be a mobile terminal/terminal device in embodiments of the disclosure, and the communication device 600 may implement corresponding operations implemented by the mobile terminal/terminal device in various methods in embodiments of the disclosure, which will not be described again herein for the sake of brevity.

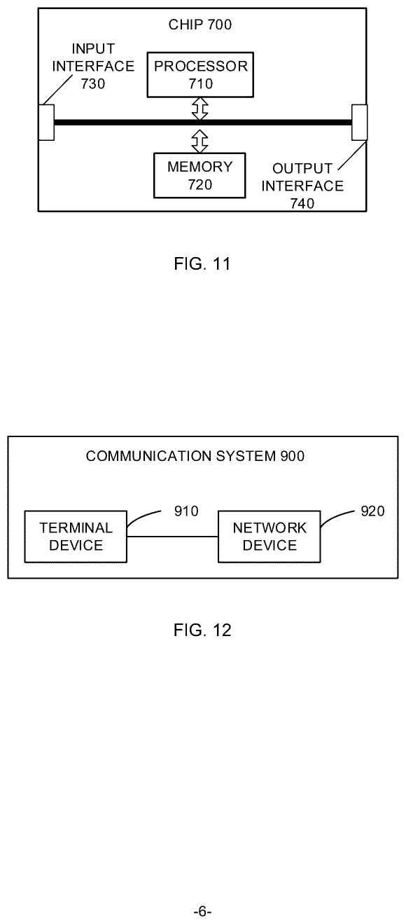

FIG. 11 is a schematic structural diagram of a chip according to embodiments of the disclosure. The chip 700 illustrated in FIG. 11 includes a processor 710. The processor 710 can invoke and execute computer programs stored in a memory, so as to implement the method in embodiments of the disclosure.

Optionally, as illustrated in FIG. 11, the chip 700 may further include a memory 720. The processor 710 can invoke and execute computer programs stored in the memory 720, so as to implement the method in embodiments of the disclosure.

The memory 720 may be a separate device independent of the processor 710, or may be integrated into the processor 710.

Optionally, the chip 700 may further include an input interface 730. The processor 710 can control the input interface 730 to communicate with other devices or chips, and specifically, to obtain information or data sent by other devices or chips.

Optionally, the chip 700 may further include an output interface 740. The processor 710 can control the output interface 740 to communicate with other devices or chips, and specifically, to output information or data to other devices or chips.

Optionally, the chip may be applied to the network device in embodiments of the disclosure, and the chip may implement corresponding operations implemented by the network device in various methods in embodiments of the disclosure, which will not be described again herein for the sake of brevity.

Optionally, the chip may be applied to the mobile terminal/terminal device in embodiments of the disclosure, and the chip may implement corresponding operations implemented by the mobile terminal/terminal device in various methods in embodiments of the disclosure, which will not be described again herein for the sake of brevity.

It should be understood that, the chip in embodiments of the disclosure may also be referred to as an SOC.

FIG. 12 is a schematic block diagram of a communication system 900 according to embodiments of the disclosure. As illustrated in FIG. 12, the communication system 900 includes a terminal device 910 and a network device 920.

The terminal device 910 may be configured to implement corresponding functions implemented by the terminal device in the foregoing method, and the network device 920 may be configured to implement corresponding functions implemented by the network device in the foregoing method, which will not be described again herein for the sake of brevity.

It should be understood that, the processor in embodiments of the disclosure may be an integrated circuit chip with signal processing capabilities. During implementation, each step of the foregoing method embodiments may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware thereof.

It can be understood that, the memory in embodiments of the disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory in the systems and methods described in the disclosure is intended to include, but is not limited to, these and any other suitable types of memory.

It should be understood that, the memory above is intended for illustration rather than limitation. For example, the memory in embodiments of the disclosure may also be an SRAM, a DRAM, an SDRAM, a DDR SDRAM, an ESDRAM, an SLDRAM, a DR RAM, etc. In other words, the memory in embodiments of the disclosure is intended to include, but is not limited to, these and any other suitable types of memory.

Embodiments of the disclosure further provide a computer-readable storage medium. The computer-readable storage medium is configured to store computer programs.

Optionally, the computer-readable storage medium may be applied to the network device in embodiments of the disclosure, and the computer programs are operable with a computer to execute corresponding operations implemented by the network device in various methods in embodiments of the disclosure, which will not be described again herein for the sake of brevity.

Optionally, the computer-readable storage medium may be applied to a mobile terminal/terminal device in embodiments of the disclosure, and the computer programs are operable with a computer to execute corresponding operations implemented by the mobile terminal/terminal device in various methods in embodiments of the disclosure, which will not be described again herein for the sake of brevity.

Embodiments of the disclosure further provide a computer program product. The computer program product includes computer program instructions.

Optionally, the computer program product may be applied to the network device in embodiments of the disclosure, and the computer program instructions are operable with a computer to execute corresponding operations implemented by the network device in various methods in embodiments of the disclosure, which will not be described again herein for the sake of brevity.

Optionally, the computer program product may be applied to a mobile terminal/terminal device in embodiments of the disclosure, and the computer program instructions are operable with a computer to execute corresponding operations implemented by the mobile terminal/terminal device in various methods in embodiments of the disclosure, which will not be described again herein for the sake of brevity.

Embodiments of the disclosure further provide a computer program.

Optionally, the computer program may be applied to the network device in embodiments of the disclosure. The computer program, when executed by a computer, is operable to implement corresponding operations implemented by the network device in various methods in embodiments of the disclosure, which will not be described again herein for the sake of brevity.

Optionally, the computer program may be applied to a mobile terminal/terminal device in embodiments of the disclosure. The computer program, when executed by a computer, is operable to implement corresponding operations implemented by the mobile terminal/terminal device in various methods in embodiments of the disclosure, which will not be described again herein for the sake of brevity.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the related art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, a ROM, a RAM, a magnetic disk, or an optical disk.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A wireless communication method, comprising:
receiving, by a terminal device, a low-power wake-up signal (LP-WUS) from a network device; and
performing, by the terminal device, physical downlink control channel
(PDCCH) monitoring after a first time offset starting from when the LP-WUS is received.

2. The method of claim 1, further comprising:
after the first time offset starting from when the LP-WUS is received, starting, by the terminal device, a discontinuous reception (DRX) inactivity timer to enter a DRX active time.

3. The method of claim 1, further comprising:
entering, by the terminal device, a DRX active time after the first time offset starting from when the LP-WUS is received.

4. The method of claim 3, wherein the terminal device stays in the DRX active time before a PDCCH indicating scheduling is received.

5. The method of claim 1, further comprising:
using, by the terminal device, a short DRX cycle, and starting a DRX short cycle timer after the first time offset starting from when the LP-WUS is received.

6. The method of claim 5, wherein performing PDCCH monitoring comprises:
performing, by the terminal device, PDCCH monitoring while a DRX on-duration timer for the short DRX cycle is running.

7. The method of claim 1, wherein the terminal device comprises a first receiver and a second receiver, wherein power consumption of the first receiver is higher than power consumption of the second receiver, and the LP-WUS is received by the terminal device via the second receiver.

8. The method of claim 7, wherein the first time offset is determined by the terminal device according to a warm-up time of the first receiver, and the warm-up time of the first receiver comprises a time elapsed from when the LP-WUS is received by the terminal device to when the first receiver of the terminal device is woken up to receive a downlink (DL) message.

9. The method of claim 1, further comprising:
sending, by the terminal device, first indication information to the network device, where the first indication information indicates the first time offset.

10. The method of claim 7, wherein the first time offset is configured by the network device via radio resource control (RRC) signaling or a media access control-control element (MAC CE).

11. The method of claim 10, wherein the first time offset is determined by the network device according to a warm-up time reported by the terminal device, and the warm-up time comprises a time elapsed from when the LP-WUS is received by the terminal device to when the first receiver of the terminal device is woken up to receive a DL message.

12. The method of claim 1, further comprising:
waking up, by the terminal device, the first receiver of the terminal device when the LP-WUS is received by the terminal device.

13. A wireless communication method, comprising:
sending, by a network device, a low-power wake-up signal (LP-WUS) to a terminal device; and
sending, by the network device, a physical downlink control channel (PDCCH) after a first time offset starting from when the LP-WUS is sent.

14. The method of claim 13, wherein sending, by the network device, the PDCCH after the first time offset starting from when the LP-WUS is sent comprises:
sending, by the network device, the PDCCH while a discontinuous reception (DRX) inactivity timer for the terminal device is running, wherein the DRX inactivity timer is started by the terminal device after the first time offset starting from when the LP-WUS is received.

15. The method of claim 13, wherein sending, by the network device, the PDCCH after the first time offset starting from when the LP-WUS is sent comprises:
sending, by the network device, the PDCCH after the terminal device enters a DRX active time, wherein the terminal device enters the DRX active time after the first time offset starting from when the LP-WUS is received.

16. The method of claim 13, wherein the PDCCH is sent while a DRX on-duration timer for a short DRX cycle is running.

17. The method of claim 13, further comprising:
sending, by the network device, second indication information to the terminal device, wherein the second indication information indicates the first time offset, wherein the second indication information is sent via radio resource control (RRC) signaling or a media access control-control element (MAC CE).

18. The method of claim 17, wherein the first time offset is determined by the network device according to a warm-up time reported by the terminal device, and the warm-up time comprises a time elapsed from when the LP-WUS is received by the terminal device to when a first receiver of the terminal device is woken up to receive a downlink (DL) message.

19. A terminal device, comprising:
a transceiver;
a memory configured to store computer programs; and
a processor configured to execute the computer programs stored in the memory, to:
cause the transceiver to receive a low-power wake-up signal (LP-WUS) from a network device; and
perform physical downlink control channel (PDCCH) monitoring after a first time offset starting from when the LP-WUS is received.

20. The terminal device of claim 19, wherein the processor is further configured to start a discontinuous reception (DRX) inactivity timer to enter a DRX active time, after the first time offset starting from when the LP-WUS is received.
